(19) United States
(12) Patent Application Publication
(10) Pub. No.: US 2003/0230013 A1
(43) Pub. Date: Dec. 18, 2003

(54) Rotary and suspending figure ornament

(76) Inventor: Paul Chang, Hsi-Chih City (TW)

Correspondence Address: RABIN & BERDO, P.C., Suite 500, 1101 14th Street, N.W., Washington, DC, 20005, US

(21) Appl. No.: 10/170,370

(22) Filed: Jun. 14, 2002

(51) Int. Cl. G09F 19/08; G09F 19/00

(52) U.S. Cl. 40/415; 40/412; 40/440

(57) ABSTRACT

A rotary and suspending figure ornament includes a candlestick and a supporting rod on one side thereof; the top portion of the supporting rod is pivotally disposed with a suspending screw-typed and gradually enlarged consecutive long decorative band. Rotary decorative pieces or objects respectively suspend at proper spaced positions on the decorative band. A heat generating source, such as a candle or a light bulb, is placed at the center of the candlestick to allow the hot air current to thrust upwardly to the bottom portion of the screw-typed decorative band thereby gradually pushing the decorative band to rotate and driving the rotary decorative pieces to rotate and swing accordingly.

### BACKGROUND OF THE INVENTION

1) Field of the Invention

The present invention relates to a rotary and suspending figure ornament, more especially to a candlestick with a screw-typed long decorative band lapped thereon requiring no externally added electric power; when the hot air from a heat generating source thrusts upwardly, it pushes the screw-typed long decorative band to continuously rotate; the present invention is characterized that the style thereof is very delicate and the structure thereof is original as well as interesting.

2) Description of the Prior Art

Accordingly, most of the conventional suspending ornaments have cute decorative elements and an additional silk string; one end of the silk string is hung up high to suspend the decorative elements for viewing. Probably, the pleasant style is worthy to look for a while, however, a static ornament is not vivid enough and its freshness will loose after a period of time. Among those suspending ornaments, only wind chimes are swung by the natural wind; most of the other ornaments need an externally added electric system, such as a battery, a motor, an electric cord and a wire seat; That is the shortcoming of the conventional structure and that not only consumes more parts and times for processing, but also wastes energy.

Furthermore, currently there is a suspending ornament similar to a marquee disposed with a proper heat source, such as a candle or a light bulb; the top aspect thereof is disposed with cover-typed vortex blades. When the heat source generates the light and heat, the hot air thrusts upwardly and the natural hot current pushes the vortex blades to rotate so as to achieve the pleasant effect of the suspending elements. However, its shortcoming is that the structure of the arch-shaped and half-covered vortex blades is more complicated and the manufacture thereof is cost and labor consuming. In addition, the style of the vortex blades is too mechanical and lacks of space for variation. That is considered as the main shortcoming of the conventional structure.

### SUMMARY OF THE INVENTION

The primary objective of the present invention is to design a delicate structure capable of rotating naturally, saving material and cost, as well as being very pleasant to look.

In order to achieve the abovementioned objective, the present invention comprises a candlestick with a heat generating source disposed at the center and a supporting rod of a proper height disposed on one side thereof. The top portion of the supporting rod is pivotally disposed with a suspending screw-typed and gradually enlarged consecutive long decorative band. Rotary decorative pieces or objects respectively suspend at proper spaced positions on the decorative band. A heat source, such as a candle or a light bulb, is placed at the center of the candlestick to allow the hot air current to thrust upwardly from the center of the bottom portion of the screw-typed decorative band thereby gradually pushing the decorative band to rotate, driving the rotary decorative pieces to rotate and swing accordingly and cooperating with the entire style. The present invention is worthy to view.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is an external view and structural drawing of the present invention.

FIG. 2 is a schematic drawing of the lateral structure and movement of the present invention.

### DETAILED DESCRIPTION OF THE PREFERRED EMBODIMENTS

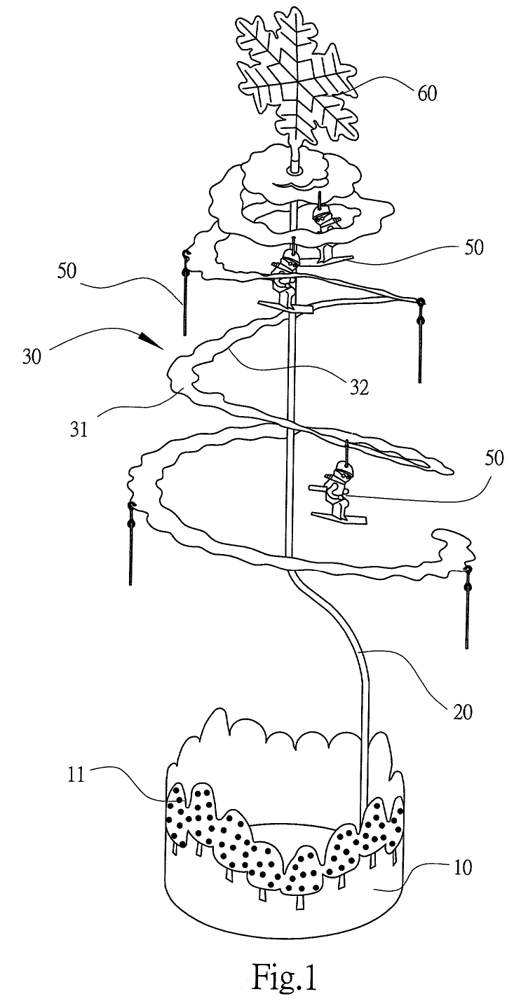

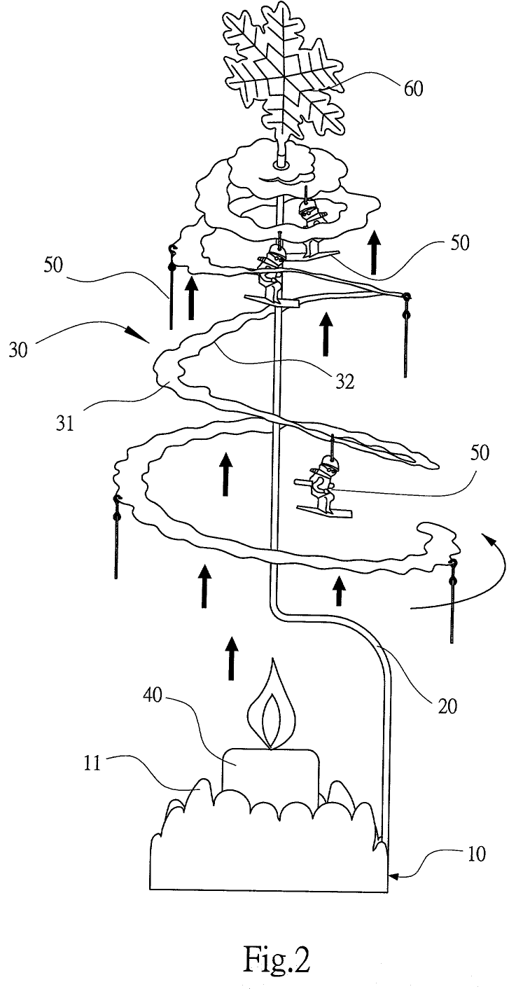

Mainly, the present invention utilizes the principle of convection of heat to design a decorative element capable of rotating naturally and having a delicate and interesting structure. Referring to FIGS. 1 and 2, the present invention mainly comprises a candlestick (10), a supporting rod (20) and other relative rotary elements; wherein the candlestick (10) has at least one heat generating source (40) disposed at the central position thereof; the heat generating source (40) can be a candle or a light bulb. The peripheral rim of the candlestick (10) is cut as a lateral panel (11) colorfully painted in snow scene. The supporting rod (20) is disposed on one side of the candlestick (10); a proper position on the rod body bends toward the central position of the candlestick (10) to be vertical with the bottom plane of the candlestick (10).

The rotary elements includes a screw-typed, expanded and gradually enlarged consecutive long decorative band (30) with wave patterns on the inner and the outer rim sides thereof. One end thereof suspends on the top portion of the support rod (20) and the band body of the decorative band (30) coils downwardly around the peripheral side of the supporting rod (20).

A plurality of rotary decorative pieces (50) cooperating with the lateral panel (11) of the candlestick (10) to form human figures in snow scenes respectively suspend at the properly spaced positions on the decorative band (30).

A top decorative piece (60) in a crystal figure of a snowflake (or of other figures) is fixedly disposed at the top portion of the supporting rod (20).

When the heat generating source (40) on the candlestick (10) starts to release the heat source, it thrusts the hot air current upwardly and pushes the bottom plane of the screw-typed decorative band (30) thereby gradually pushing the decorative band (30) to rotate and driving the rotary decorative pieces (50) to swing accordingly in a dynamic state as very beautiful, innovative and rotary elements.

Especially, the peripheral rim of the candlestick (10), the rotary decorative pieces (50) and the top decorative piece (60) can all be designed into a similar style, such as a snow scene, for obtaining a more brilliant and gorgeous effect.

The present invention is specially elaborated to not only have beautiful and variable visual effect in application, but also eliminate the disposition of other dynamic equipment by merely utilizing a luminous apparatus thereby saving resources. That is the primary advantage of the present invention.

Secondly, the decorative band (30) is a screw-typed band not only having pleasant appearance and simple structure, but also capable of efficiently saving the cost.

Furthermore, another advantages of the present invention are that the lateral panel (11) on the peripheral rim of the candlestick (10) is colorfully painted and cut into a snow scene, a top decorative piece (60) is disposed uprightly on the upper end of the supporting rod (20), white colored wave patterns (32) are disposed on the inner and outer rims of the decorative band (30), the rotary decorative pieces (50) disposed on the peripheral side of the band body is designed as snow covered ground and human figures and the top decorative piece (60) is designed as a crystal figure of a snowflake on the supporting rod (20) so as to form an interesting and ingenious snow scene.

The inventor of the invention has designed the present invention to be beautiful, have the energy saving effect, interesting ideas and exquisite innovation.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A rotary and suspending figure ornament comprising a candlestick, a supporting rod and other relative rotary elements, wherein a heat generating source is disposed on the candlestick and the supporting rod is disposed vertically on one side of the candlestick; the present invention is characterized that:
the rotary elements disposed on the supporting rod includes a screw-typed, expanded and gradually enlarged consecutive long decorative band with one end thereof suspending on the top portion of the support rod; the band body of the decorative band coils downwardly around the peripheral side of the supporting rod;
more than one rotary decorative pieces suspend at the proper positions on the decorative band; when the heat generating source of the candlestick starts to release the heat source, it thrusts the hot air current upwardly to the bottom portion of the screw-typed decorative band to gradually push the decorative band to rotate and drive the rotary decorative pieces to swing accordingly.

2. The rotary and suspending figure ornament according to claim 1, wherein the outer lateral rim of the decorative band has wave patterns.

3. The rotary and suspending figure ornament according to claim 1, wherein the inner lateral rim of the decorative band has wave patterns.

4. The rotary and suspending figure ornament according to claim 1, wherein the upper end of the supporting rod is disposed with an upright top decorative piece.

5. The rotary and suspending figure ornament according to claim 1, wherein the peripheral rim and the rotary decorative pieces are designed as a similar style.

6. The rotary and suspending figure ornament according to claim 5, wherein a lateral panel on the peripheral rim of the candlestick is colorfully painted and cut into a snow scene and the rotary decorative pieces are human figures on a snow covered ground.

7. The rotary and suspending figure ornament according to claim 4, wherein the top decorative piece is a crystal figure of a snowflake.
